(19) United States
(12) Patent Application Publication
(10) Pub. No.: US 2026/0281679 A1
(43) Pub. Date: Sep. 17, 2026

(54) METHODS TO INFORM APPLICATION CLIENTS IN PINE ABOUT IP CONNECTION CHANGES AT PEGC

(71) Applicant: InterDigital Patent Holdings, Inc., Wilmington, DE (US)

(72) Inventors: Debashish Purkayastha, Eagleville, PA (US); Anuj Sethi, Ottawa (CA); Michael Starsinic, Newtown, PA (US); Saad Ahmad, Montreal (CA)

(73) Assignee: InterDigital Patent Holdings, Inc., Wilmington, DE (US)

(21) Appl. No.: 19/168,206

(22) PCT Filed: Apr. 10, 2024
(86) PCT No.: PCT/US2024/023793

§ 371 Date: Sep. 23, 2025

Related U.S. Application Data
(60) Provisional application No. 63/458,312, filed on Apr. 10, 2023.

(51) Int. Cl. H04W 4/70; H04W 76/11

(52) U.S. Cl. CPC H04W 4/70; H04W 76/11

(57) ABSTRACT

A wireless transmit/receive unit (WTRU) may comprise a processor and memory. The WTRU may receive a subscription request from a personal internet of things (PIN) client. The first subscription request may indicate a request to be notified about changes to an internet protocol (IP) connection identified by an identifier. The WTRU may identify a change to the IP connection identified by the identifier. The WTRU may send a notification to the PIN client that indicates the change to the IP connection and the cause of the change to the IP connection.

### CROSS-REFERENCE TO RELATED APPLICATIONS

This application claims the benefit of U.S. Provisional Patent Application No. 63/458,312 filed on Apr. 10, 2023, the entire contents of which are incorporated herein by reference.

### BACKGROUND

A personal IoT network (PIN) may be a configured and/or managed group of PIN elements (PEs) able to communicate with each other directly and/or via PIN elements with gateway capability (PEGC). The PIN may communicate with a 5G network via at least one PEGC, and/or managed by at least one PIN element with management capability (PEMC). A PINE may be a user equipment (UE), which may be referred to interchangeably with a wireless transmit receive unit (WTRU), and/or non-3GPP device that may communicate within a PIN (via PIN direct connection, via PEGC, via PEGC and/or 5G core network (5GC)), and/or outside the PIN via a PEGC and/or 5GC. A PEGC may be a PINE with the ability to provide connectivity to and/or from the 5G network for other PINEs, and/or to provide relay for the communication between PINEs.

Existing PINs may make the following architectural assumptions: a 3GPP WTRU may act as PEGC and/or PEMC. There may be one or more PEGCs in a PIN. There may be one or more PEMCs in a PIN. At any point of time one of the PEMCs may control the PIN. The PINEs may use non-3GPP access (e.g. WIFI, Bluetooth) for direct communication, the PEMC may use 5G (e.g., 5G ProSe Direct Communication) for direct communication with PEGC. The PEGC and/or PEMC may belong to same public land mobile network (PLMN) and/or standalone non-public network ((SNPN). A single PEGC may support more than one PIN at a time.

### SUMMARY

Methods, systems, and/or apparatuses are provided herein to inform application clients in a personal internet of things (IoT) network (PIN) element about internet protocol (IP) connection changes at a PIN element (PINE) with gateway capability (PEGC). A PEGC client may become aware of the status of an IP connection with the network and/or may inform a PIN client in a PINE. The PIN client may inform one or more application clients about the status of the IP connection with the network. A PINE with management capability (PEMC) client may become aware of the status of an IP connection with the network (e.g., from a PIN server). An application function (AF) for the PIN and/or the PEGC client may inform a PIN client in a PINE about the status of the IP connection. The PIN client may inform one or more application clients about the status of the IP connection.

A wireless transmit/receive unit (WTRU) may comprise a processor and memory. The WTRU may receive a subscription request from a PIN client. The first subscription request may indicate a request to be notified about changes to an IP connection identified by an identifier. The WTRU may identify a change to the IP connection identified by the identifier. The WTRU may send a notification to the PIN client that indicates the change to the IP connection and the cause of the change to the IP connection. The notification may be a first notification. The WTRU may determine that the IP connection has returned to normal operation based on receipt of a second notification from a PIN server, an AF, and/or a PEMC. The second notification may include an indication that the IP connection has returned to normal operation.

The WTRU may send a third notification to the PIN client that indicates that a packet data unit (PDU) session has returned to normal operation. The may establish the IP connection with the network. The IP connection may include a PDU session.

The change to the IP connection may include a disabled connection. The IP connection may include IP connection events. The IP connection events may include one or more of congestion in data network name (DNN), mobility, an application of application of non-access stratum mobility management (NAS MM) congestion control, an application of non-access stratum session management (NAS SM) congestion control, a change in IP address, connection migration, congestion with a timer, a release of the PDU session, and/or a re-establishment of the PDU session.

The subscription request may include an indication of which events should trigger the notification. The events that trigger the notification may include one or more of a PDU session release, detection of application of NAS MM congestion control, and/or detection of application of SM congestion control.

The notification may include a timer indicating an expected duration of the change to the PDU session. The WTRU may monitor the IP connection for a change in connectivity status.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram depicting an example personal internet of things (IoT) networks architecture.

FIG. 3 is a diagram depicting an example home automation personal IoT network (PIN).

FIG. 4 is a diagram depicting an example wearable PIN.

FIG. 5 is a diagram depicting an example gateway function.

FIG. 6 is a diagram depicting an example application layer support for PIN (PINAPP).

FIG. 7 is a call flow depicting an example PIN elements with gateway capability (PEGC) client that notifies PIN element (PINE).

FIG. 8 is a call flow depicting an example PIN element with management capability (PEMC) client that notifies PINE.

FIG. 9 is a call flow depicting an example PEMC client that notifies PINE by obtaining information from PEGC client.

### DETAILED DESCRIPTION

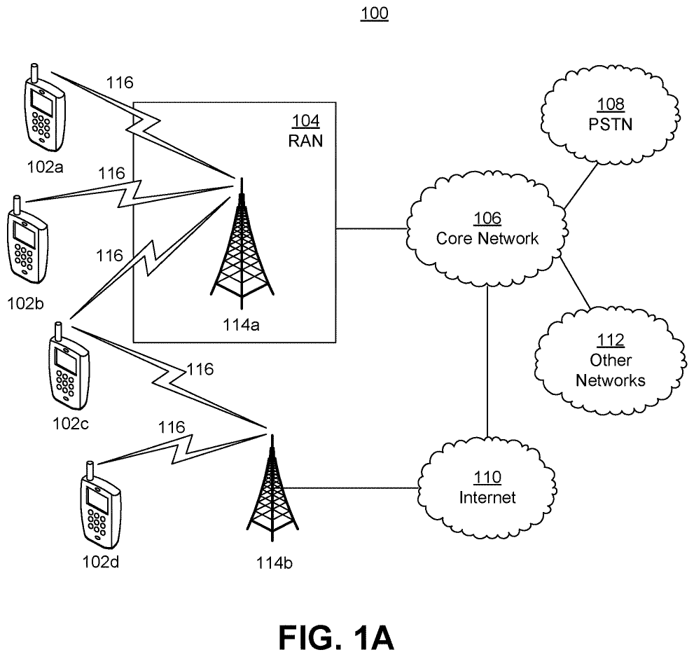

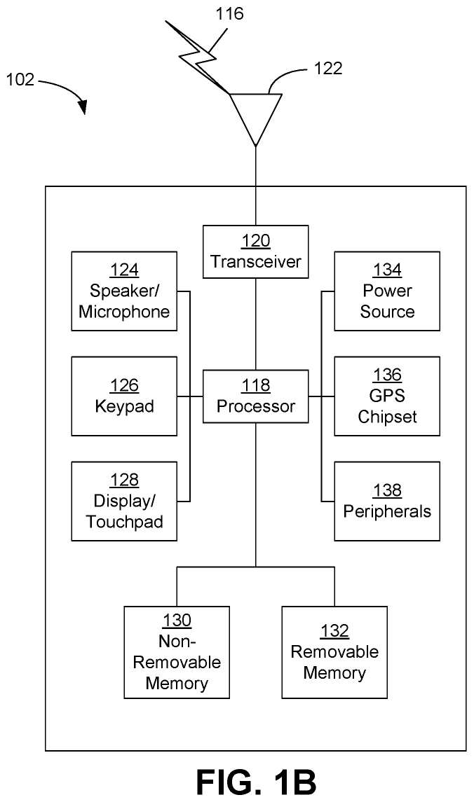

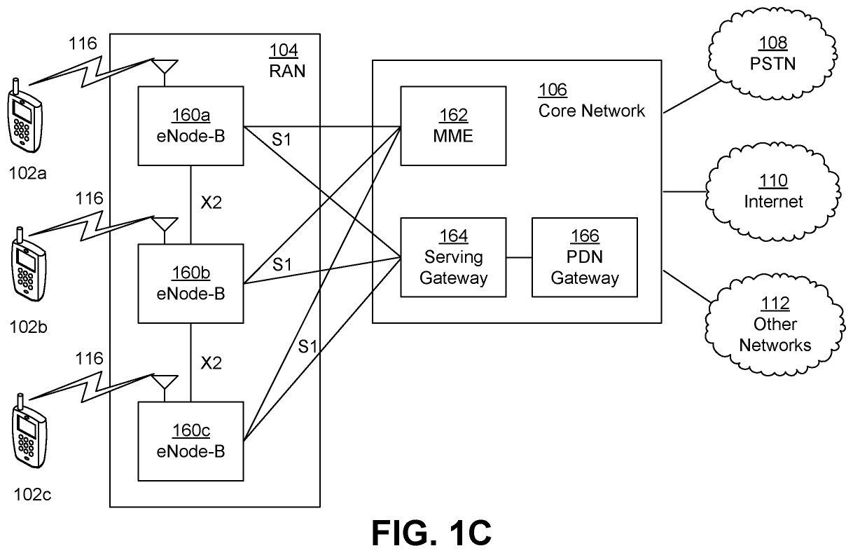

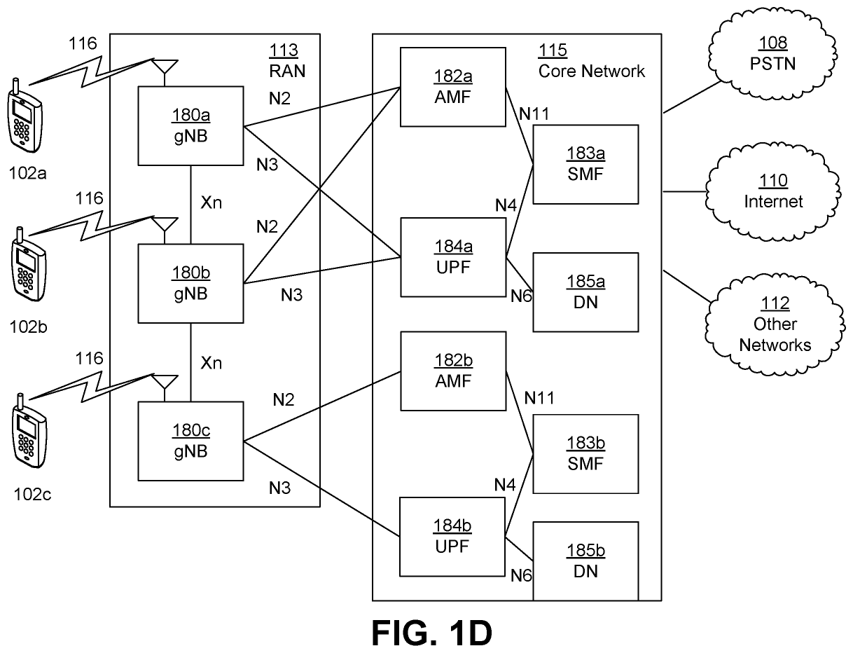

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel—cadmium (NiCd), nickel—zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUS 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A Personal IoT Network (PIN) may be a configured and/or managed group of PIN elements able to communicate with each other directly and/or via PIN elements with gateway capability (PEGC). The PIN may communicate with a 5G network via at least one PEGC and/or managed by at least one PIN element with management capability (PEMC).

A PIN element (PINE) may include a WTRU and/or a non-3GPP device. The PINE may communicate within a PIN (e.g., via PIN direct connection, via PEGC, and/or via PEGC and/or 5GC), and/or outside the PIN via a PEGC and/or 5GC.

A PEGC may be a PIN element with the ability to provide connectivity to and/or from the 5G network for other PIN Elements. The PEGC may provide relay for the communication between PIN elements.

A PEMC may be a PIN element with capability to manage the PIN.

PINE-to-PINE communication may include communication between two PINES. PINE-to-PINE communication may include PINE-to-PINE direct communication and/or PINE-to-PINE indirect connection.

PINE-to-PINE direct connection may be the connection between two PIN elements without PEGC, any 3GPP RAN, and/or core network (CN) entity in the middle.

PINE-to-PINE indirect connection may be the connection between two PIN Elements via PEGC and/or via a user plane function (UPF).

PINE-to-PINE routing may include routing traffic by a PEGC between two PINEs (e.g., the two PINEs directly connect with the PEGC via non-3GPP access).

PINE-to-Network routing may occur when a PEGC routes traffic between PINE and/or 5GS. The PINE may directly connect with the PEGC via separate non-3GPP access.

Network local switch for PIN may occur when UPF(s) route traffic between two PINEs. The two PINEs may directly connect with two PEGCs via separate non-3GPP access.

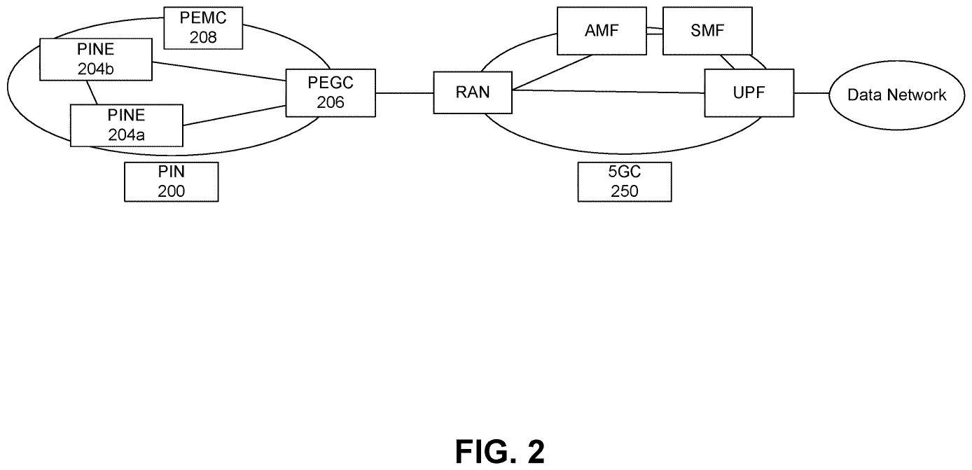

FIG. 2 depicts an example PIN architecture. As depicted in FIG. 2, a PIN 200 may be a configured and/or managed group of PINEs 204a, 204b. The PINEs 204a, 204b may communicate with each other directly and/or via PEGC 206, communicate with the network (e.g., the 5G network 250) via at least one PEGC, and/or managed by at least one PEMC 208. A PINE 204a, 204b may be a UE, which may be referred to interchangeably with a wireless transmit receive unit (WTRU). A PINE 204a, 204b and/or non-3GPP device may communicate within a PIN (e.g., via PIN direct connection, via PEGC, via PEGC and/or the network), and/or outside the PIN via a PEGC and/or the network. The PEGC 206 may be a PINE 204a, 204b with the ability to provide connectivity to and/or from the network (e.g., the 5G network 250) for other PIN Elements, and/or to provide relay for the communication between PINEs 204a, 204b.

Existing PINs may include one or more of the following architectural assumptions: a 3GPP WTRU (e.g., only a 3GPP WTRU) may act as PEGC and/or PEMC. A PIN may include one or more PEGCs. A PIN may include one or more PEMCs. At any point of time one of the PEMCs may control the PIN. The PINEs may assume to use non-3GPP access (e.g. WIFI, Bluetooth, etc.) for direct communication, the PEMC may use 5G (e.g., 5G ProSe Direct Communication) for direct communication with PEGC. The PEGC and/or PEMC may belong to same public land mobile network (PLMN) and/or standalone non-public network (SNPN). A single PEGC may support more than one PIN at a time.

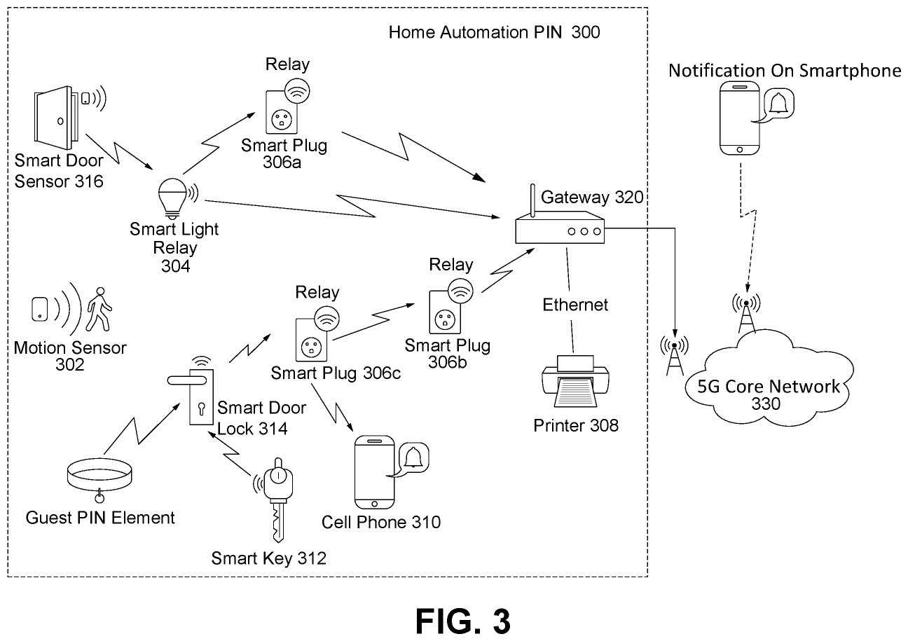

FIG. 3 depicts an example home automation PIN 300. The Internet of Things (IoT) feature has been designed for devices that communicate using the traditional cellular network. Devices with IoT capabilities may require better power consuming performance and/or increased network efficiency for bulk operations.

When multiple IoT devices may be deployed in a private environment, the user equipment (UEs), which may be referred to interchangeably with wireless transmit/receive units (WTRUs) with IoT capabilities, may be organized in a PIN 300.

For example, in the home environment, a residential gateway 320 may manage devices such as motion sensor 302, smart light 304, smart plug 306a, 306b, 306c, printer 308, cellphone 310, smart key 312, smart door lock 314, smart door sensor 316, etc. These devices may communicate with each other. In this case, all devices in the home constitute the PIN 300. Each device is called a PIN element (PINE) and different PINEs have different capabilities. For example, the residential gateway 320 may have PIN element with gateway capability (PEGC) to provide connections between PINEs and/or connections between 5G network 330 and/or PINEs. A PIN element with management capability (PEMC) is a PINE that may allow an authorized administrator to configure and/or manage a PIN (e.g., such as the PIN 300). The residential gateway 320, which acts as a PEGC, may support PIN management function as well. Further, the residential gateway 320 may act as a PEMC.

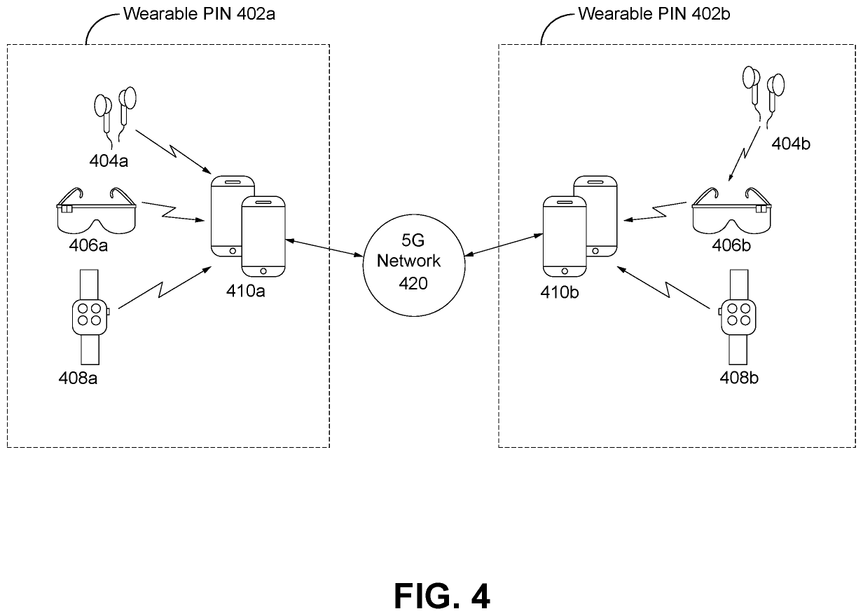

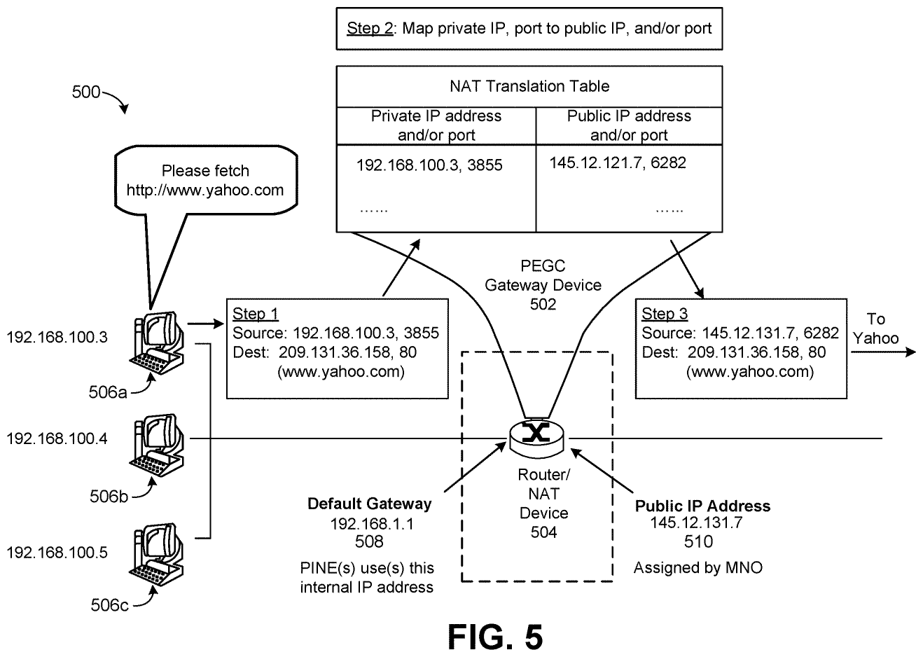

FIG. 4 is a diagram depicting an example wearable PIN. As seen in FIG. 4, wearable devices (e.g., airpods 404a, 404b; VR/AR glasses 406a, 406b; and/or smart watches 408a, 408b) may also constitute another kind of PIN, e.g. a wearable PIN 402a, 402b. In this type of PIN, a smart phone 408a, 408b may act as, e.g., a PEGC and/or a PEMC. Herein, the airpods 404a, VR/AR glasses 406a, and/or smart watches 408a, may communicate with each other in the PIN 402a (e.g., via a short-range wireless technology such as Blue Tooth). The PIN 402a may communicate with a PIN 402b via 5G network 420. FIG. 5 depicts an example gateway function 500. As seen in FIG. 5, a PEGC may be a PINE with the ability to provide connectivity to and from the 5G network for other PINEs, or to provide relay for the communication between PINEs.

PEGC 502 as a gateway and/or relay may support establishing a local area network (LAN) with PINEs. PEGC may operate via an explicit internet protocol (IP) addressing scheme and/or run dynamic host configuration protocol (DHCP) services. In case of IPv6, PEGC may be provided with a IPv6 prefix, PEGC may assign local IP address with the prefix to the clients. The diagram depicted in FIG. 5 may describe the operation of PEGC 502, providing gateway function.

PEGC 502 may provide network address translation (NAT) 504. NAT 504 may allow for the modification of certain packets' addresses. Modifying certain packets' addresses may allow the PEGC to route those packets entering the LAN via one address to a specific internal address.

PEGC 502 may be mobile and/or change IP address due to handover. 5GS may define the mechanism to handle changes in IP address using SSC modes.

Referring to FIG. 5, as an example of a BODY AREA NETWORK, the PEGC 502 may provide 5GS connectivity to other sensors in the body area. In this configuration the following behavior may be assumed: the local IP address for PINEs 506a, 506b, 506c and DEFAULT GATEWAY address 508 of PEGC 502 may remain same, e.g., 192.168.1.1 for the PEGC 502 and 192.168.100.3, 192.168.100.4, and 192.168.100.5 for PINEs 506a, 506b, 506c, respectively. The public IP address 510 may change as the PEGC 502 moves. Considering service and session continuity (SSC) modes, the public IP address 510 may be, e.g., SSC mode 1: may remain 145.12.131.7; SSC mode 2: may change from 145.12.131.7 to 145.12.132.8; and/or SSC mode 3: may change from 145.12.131.7 to 145.12.131.7 and 145.12.132.8 and again to 145.12.132.8. For IPv6, the same scenario may be assumed. The prefix assigned to gateway may change. When the prefix changes and/or no NATing is available, the gateway may assign a local IP address based on the new prefix.

. When SSC mode 2 is used, the network may release the connectivity service delivered to the WTRU. The network may release the corresponding protocol data unit (PDU) session(s). The release of the PDU session may induce the release of IP address(es) that had been allocated to the WTRU.

If a PDU session has a single PDU session anchor the network may trigger the release of the PDU session and/or instruct the WTRU to establish a new PDU session to the same data network immediately.

If a PDU session has multiple PDU session anchors (e.g., in the case of multi-homed PDU sessions or in the case that UL CL applies to a PDU session), the additional PDU session anchors may be released or allocated.

When SSC mode 3 is used, the network may preserve the connectivity provided to the WTRU. However, there may be some impact during certain procedures. For example, the IP address allocated to the WTRU may be updated if the anchor UPF changes. In this case, the change procedure may ensure that connectivity is preserved (e.g., connectivity towards the new anchor UPF may be established before releasing the connection to the old anchor UPF).

The IP address may not be preserved when the PDU session anchor changes. The new anchor may be associated to a new PDU session and/or to the same PDU Session (e.g., multi-homing)

For SSC mode 3 with multiple PDU Sessions, a new PDU session may be established with a new anchor. New prefixes may need to be sent to a remote WTRU to make use of this new PDU session and/or anchor. Old prefixes may still be used before old PDU session is released. A PDU session address lifetime may be provided as part of the PDU session modification procedure.

For SSC mode 3 with change of PDU session anchor (e.g., multi-homed PDU session), IPv6 prefixes from the new anchor may be associated to the existing PDU session. Moreover, IPv6 prefixes may be sent to the remote WTRU to use the new PDU session anchor. Old prefixes may still be used.

The 3GPP Work Group SA6 is a studying application layer support for PINs. The aspects of the study include analyzing application layer architecture requirements of PIN, identifying key issues, and/or supporting PIN application layer functional model.

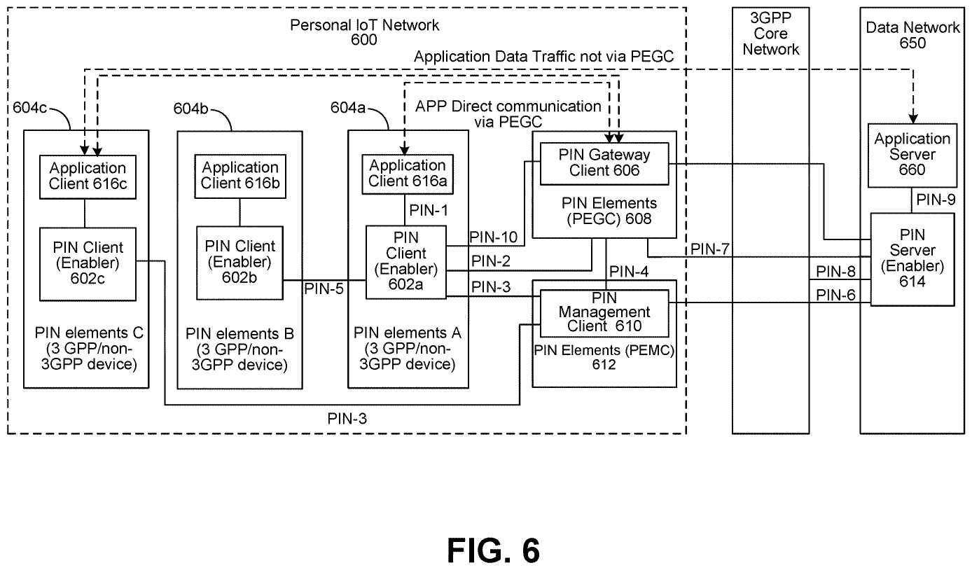

FIG. 6 depicts an example PIN application (PINAPP) architecture 600. The PINAPP 600 structure shown in FIG. 6 may enable application layer support.

Application entities such as PIN clients 602a, 602b, 602c in a PINE 604a, 604b, 604c, respectively, PIN gateway client 606 in PEGC 608, PIN management client 610 in PEMC 612, and/or PIN server 614 in data network 650 may be part of the PINAPP 600 architecture and/or enables the desired feature in a PIN. Herein described are these functional entities and/or the PIN node to enable PINAPP 600 feature. The PIN node may assume the PIN functional entities (e.g., PINE 604a, 604b, 604c), and/or refer to the PIN client 602a, 602b, 602c. The PEMC 612 may refer to PIN management client 610. The PEGC 608 may refer to the PIN gateway client 606.

Problems may relate to operation of application clients (ACs) in a PINE, when PEGC faces a problem with the IP connection towards 5GC. A PEGC may provide IP connectivity to PINEs towards the 5GC. IP traffic from ACs in a PINE may flow from the PINE to a PEGC and then to a UPF in the 5GC. An AC in a PINE may be an end-to-end IP connection unaware of the PEGC in the middle.

PEGC may face various issues with the IP connections towards 5GC. These issues may cause a disruption in the end-to-end IP connection between the PINE and any application server that the PINE may communicate. Examples of issues experience include, e.g., mobility, congestion control, and/or PDU session release/re-establishment, etc.

Due to mobility, the PEGC may change its anchor point in the 5GC (e.g., UPF). This may result in a change of IP address. Managing these changes may depend on the SSC mode associated with the PDU session a CN. In SSC mode 2, the PEGC may be assigned a new IP address when the WTRU's UPF changes. The new IP address may be assigned because the PEGC breaks the old connection (e.g., PDU Session) and/or establishes a new connection (e.g., PDU Session). The time between PDU session release and/or PDU session establishment, there exists a period where the WTRU may have no IP connection for PIN traffic. In SSC mode 3, the PEGC may transition from an existing connection (e.g., PDU session) to a new connection (e.g., PDU session).

When the WTRU begins using the new PDU session for PIN traffic, then the IP address associated with the PIN traffic may change. This may result in a delay and/or retransmission as the source and/or destination adjusts state.

The SMF and/or 5GC may inform the PEGC about congestion in the data network name (DNN) and/or inform the PEGC to start a backoff timer. When the backoff timer runs, the PEGC may be barred from generating session management signaling and/or traffic for the associated PDU session.

The 5GC may request that the PEGC release and/or re-establish a PDU session (e.g., by setting rejection cause code as “re-activation”). This may happen when using SSC mode 2. However, the network may also generate this request for PDU sessions of SSC modes 1 and/or 3.

ACs in a PINE may not be aware of the condition of the IP connection faced by PEGC. Due to mobility and/or waiting for the backoff timer to expire, ACs may face delays and/or retransmission error while the PEGC waits to establish the IP connection. ACs may assume permanent loss of connectivity and/or reset the connection. This may degrade the overall performance, as re-establishing the IP connection takes much longer time than re-transmitting a packet, which was lost. ACs may be unaware of the condition in PEGC and/or how a network takes action to restore the connectivity. As a result, the network's actions may become less useful.

An AC in a PINE may be prevented from resetting an IP connection. The AC may take appropriate action to continue maintaining the application layer session, for example, when various temporary issues with IP connection between PEGC and 5GC causes the connection interruption. Such examples may include one or more of the following: connection un-availability and/or session transfer from one existing connection to another existing connection due to mobility and/or allowed SSC mode may cause correction interruption. A PEGC under congestion control as informed by the 5GC and/or SMF to backoff using a backoff timer may cause correction interruption. The PEGC receiving a request from the network to release and/or re-establish a PDU session may cause correction interruption.

A PIN may be a configured and/or managed group of PINEs able to communicate with each other directly and/or via a PEGC. The PIN may communicate with the network (e.g., 5G network) via at least one PEGC. The PIN may be managed by at least one PEMC. A PINE may be a WTRU and/or non-3GPP device. The PINE may communicate within a PIN (e.g., via PIN direct connection, via PEGC, via PEGC and/or 5GC), and/or outside the PIN via a PEGC and/or 5GC. A PEGC may be a PINE with the ability to provide connectivity to and/or from the network (e.g., 5GC) for other PINE, and/or to provide relay for the communication between PINE.

Disclosed herein are mechanisms to support improved operation of ACs in a PINE by making the PINE aware of the IP connectivity status experienced by the PEGC. The PINE AC may take temporary action based on the information from PEGC and/or know to not try to re-establish the IP connection.

Enhanced PEGC functionality may be provided. For example, the PEGC client may be aware of the status of the IP connection. The PEGC client may notify the status to the PINE client. The PINE client may provide the information to the AC to take appropriate action.

Additionally or alternatively, a PIN server in the network (e.g., 5GC) and/or an external AF may make a PINE aware of the IP connectivity issues. A PIN server and/or an AF may notify a PEMC client about the IP connection issues at the PEGC. The PEMC may inform specific and/or selected PINEs about the IP connection issues.

A PINE (e.g., a PIN Client) may be notified about the IP connectivity status between PEGC and/or the network (e.g., 5GC). In an example, the PEGC client may notify the PIN client in the PINE of connectivity issues. The PEGC client may become aware of the different causes related to IP connectivity issues. The PEGC client may inform the PIN client when it becomes aware of the IP connection condition. Later, when the condition improves, the PEGC client may inform the PIN client about the improved condition of IP connectivity.

Alternatively, the PEMC client may notify the PIN client. The PEMC client may obtain information about IP connection status at PEGC, from PIN server, AF, and/or PEGC client.

A PEGC client (e.g., a WTRU having a PEGC client) may notify a PINE about IP connectivity status. A WTRU (e.g., a PEGC client in the WTRU) may perform one or more the following to notify a PIN client about IP connectivity status: the WTRU may receive one or more subscription requests from a PIN client in the PINE. The one or more subscription requests may be requests to be notified about any changes to the state of an IP session identified by a session ID. The WTRU may identify a PDU session based on the session ID. The WTRU may send a subscription request to be notified about changes in the state of the PDU session. The WTRU may send the subscription request to a mobile termination (MT) part of the WTRU that hosts the PEGC client. The WTRU may send the subscription request by invoking an application programming interface (API) and/or an attention (AT) command. The subscription request may indicate which events should trigger a notification, e.g., PDU session release and/or detection of application of non-access stratum (NAS), mobility management (MM), and/or session management (SM) congestion control. The WTRU may receive a notification from the MT part of the WTRU about the PDU session. The notification may indicate a change in the state of the PDU session. The notification may indicate a cause for the state change, for example, such as application of NAS, MM, SM congestion control, and/or release of the PDU session.

The notification may include a timer. The timer may indicate how long the state change is expected to last. For example, when the cause is due to NAS, MM, and/or SM congestion control, the timer may indicate how long the congestion situation is expected to last. The notification may indicate a cause for the PDU session release. The notification may indicate if the MT part of the WTRU may be attempting to re-establish the PDU session.

The WTRU may send a notification to the PINE about the state of the IP connection and/or the reason for change. The PINE may take appropriate action upon receipt of the notification about the state of the IP connection. For example, the PINE may buffer, pause, and/or delay sending data associated with the PDU session in response to the notification. When the PDU session returns to normal operation, the WTRU may become aware of a change in connection state, e.g., to normal and/or improved. The PEGC may become aware of the state change based on a notification from the MT part of the WTRU. The WTRU may notify the PINE about a change with status and/or any event such as change in IP address, etc. The PINE may take appropriate action and/or resume operation based on the notification about the change of status.

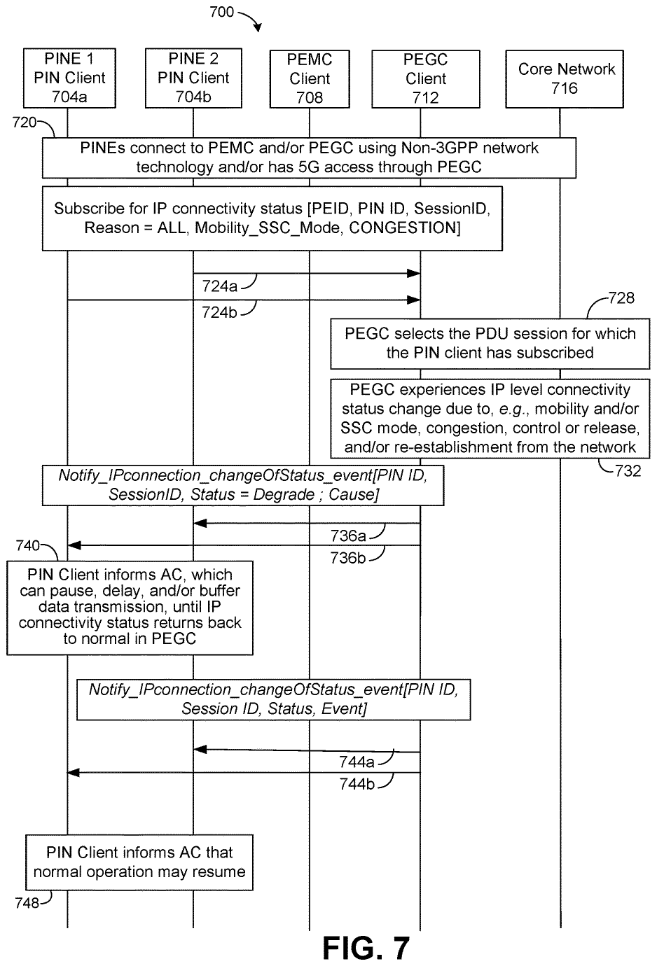

FIG. 7 depicts an example procedure 700 of a PEGC client 712 (e.g., a PEGC client in a WTRU) notifying a PINE about IP connectivity status. At 720, PINE 1 and/or PINE 2 may be part of the PIN 704a, 704b. The PIN 704a, 704b may connect to the network 716 (e.g., 5GC) through a PEGC client 712. The AC in each PINE 704a, 704b may setup an IP session (e.g., IP connection) with the network (e.g., 5GC) through the PEGC client 712.

At 724a, 724b, the AC in a PINE may trigger the PIN client 704a, 704b to subscribe for an IP connection status related notification. The PIN client 704a, 704b may subscribe to a PEGC client 712, for example, to get notified about IP connection events for various reasons like mobility, change in IP address, congestion in DNN, release and/or re-establish of PDU session, etc. The PIN client 704a, 704b may subscribe to the PEGC client 712 to be notified for a specific reason or for any reason. The PIN client 704a, 704b may send a subscription request to the PEGC client 712. The subscription request may include the session ID that the PIN client 704a, 704b requests to be notified about.

At 728, the PEGC client 704a, 704b may select the PDU session, which the PIN client 704a, 704b wants to be notified about, based on PINE ID, PIN ID, and/or Session ID. The PEGC client 712 may start monitoring the PDU session for change in connectivity status due to mobility, SSC mode, congestion, release and/or re-establish or other reasons by subscribing to events related to the PDU session, using API and/or AT commands. The 5GC may provide a cause value to the PEGC client 712 for PDU session modification and/or update. PEGC client 712 may be notified about the cause through APIs, and/or AT commands, etc.

At 732, the PEGC client 712 may experience IP level connectivity status change for the PDU session selected. For example, the PEGC client 712 may identify, at 732, a change to the IP connection (e.g., that is identified by the session ID). The PEGC client 712 may be informed about the connectivity status and/or the cause such as mobility and/or SSC mode, congestion control or release, and/or re-establish from the network 716 (e.g., 5GC).

At 736a, 736b the PEGC client 712 may inform the PIN client 704a, 704b about IP connection disruption with possible cause such as, e.g., “change in IP address, SSC mode2” “connection migration, SSC mode 3,” “congestion with a timer, SM,” and/or “release and re-establish,” etc. For example, the PEGC client 712 may send at 736a, 736b, a notification to the PIN client(s) 704a, 704b that indicates the change to the IP connection and the cause of the change to the IP connection. The PEGC client 712 may send notification messages to those PINEs which subscribed to get notified. The notification may indicate that the IP connection is temporarily disabled. The notification may indicate that the IP connection is intact, but the IP address had changed. The notification may indicate the new IP address. The notification may indicate that the IP connection is intact, but that the connection is now associated with two IP addresses. The notification may indicate the IP address(es) associated with the connection. The notification may indicate that an IP address may no longer be associated with the connection. The notification may include a time value that indicates how long the IP connection may be disabled. The time value may be based on a back-off timer received from the network. The notification may indicate that the IP connection may no longer be disabled (e.g., enabled).

At 740, the PIN client 704a, 704b may select the AC based on a PIN ID and/or a session ID associated with the notification. The PIN client 704a, 704b may inform the AC about the “IP connection status change” notification. The AC may take actions to continue the session and does not reset and/or re-establish connection.

If the IP connection is temporarily disabled and a new IP address is going to be assigned, the AC may start buffering IP packets and/or pause the application temporarily, for example, so that new IP packets are not generated.

If the IP connection is temporarily impacted because the PDU session has been assigned two IP addresses and one IP address will no longer be associated, the AC may buffer IP packets. Buffering IP packets may allow the application to retransmit if any packets are lost during transition. The AC may also generate application packets at a slower rate.

If the IP connection is temporarily unavailable indicated by a time value, the AC may also pause the application from generating IP packets for the same amount of time.

At 744a, 744b, when the IP connection issue for the specific session ID and/or PIN ID is resolved at PEGC, the PEGC client 712 may send another notification to PIN client 704a, 704b. For example, the PEGC client 712 may determine that the IP connection has returned to normal operation, for example, based on receipt of a notification from a PIN server, an application function, or the PEMC client 708. The PEGC client 712 may send the notification at 744a, 744b with information such as state of the connection and/or optionally any event that happened such as a changed IP address (e.g., IPv6 prefix) of PEGC and/or a new port number.

The notification sent at 744a, 744b may indicate that the issues with the PDU session associated with the IP connection have been resolved. The notification may indicate that the IP connection is in normal situation and/or the IP connection is intact. The notification may include the IP address, (e.g., if the IP address changed). The notification may also include a new IP address assigned to PINE, when there is no NAT. The notification may include port number, for example, if the port number changed. The notification may indicate that the IP connection is no longer disabled (e.g., enabled).

If a PINE is notified about a change in its own IP address, the PINE may update its own IP address.

At 748, the PIN client may inform the AC about the IP connection status change notification received. The AC, after receiving the notification, may abort one or more actions initiated to continue a session.

A PEMC client (e.g., a WTRU having a PEMC client) may notify a PINE about an IP connection status by obtaining information from 5GC (e.g., PIN server, and/or AF). A PEMC client may notify a PIN client about the IP connection status. A WTRU (e.g., a PEMC client in the WTRU) may perform one or more of the following to notify the PIN client about the IP connection status: the WTRU may receive subscription requests from a PIN client in a PINE. The subscription requests may request notification about any changes to an IP session identified by a session ID. The WTRU may send a subscription request to be notified about changes in the state of the IP session.

The subscription request may be sent to a PIN server in the core network. The PIN server may identify the corresponding PDU session. The subscription request may subscribe with the network (e.g., 5GC) through an API. The subscription requests may request notification about any changes in the PDU session. The subscription request may indicate which event(s) should trigger a notification, e.g., PDU session release and detection of application of NAS, MM, and/or SM congestion control.

The subscription request may be sent to an AF for the PIN outside the core network. The AF may identify the corresponding PDU session. The WTRU may subscribe with the network (e.g., 5GC) through a network exposure function (NEF) application program interface (API), to be notified about any changes in the PDU session. The subscription request may indicate which events should trigger a notification, e.g., a PDU session release and/or detection of application of NAS, MM, and/or SM congestion control.

The subscription request may be sent to a PEGC client. WTRU may determine the PDU session based on the session ID. The subscription request may be sent to the MT part of the WTRU that hosts the PEGC client. The subscription request may be sent by invoking an API and/or an AT command. The subscription request may indicate which events should trigger a notification, e.g., PDU session release and/or detection of application of NAS, MM, and/or SM congestion control.

The WTRU may receive a notification from a PEGC client. The PEGC client may have been notified by the MT part of the WTRU about the PDU session. The WTRU may receive a notification from a PIN server in 5GC. The PIN server in 5GC may have been notified by 5GC about the PDU session. The WTRU may receive a notification from the AF. The network (e.g., 5GC), through NEF, may notify the AF about the PDU session. The notification may indicate a change in the state of the PDU session. The notification may indicate a cause for the state change such as application of NAS, MM, and/or SM congestion control and/or release of the PDU session.

The notification may include a timer that indicates how long the state change is expected to last. For example, when the cause is due to NAS, MM, and/or SM congestion control, the timer may indicate how long the congestion situation is expected to last. The notification may indicate a cause for the PDU session release. The timer may indicate the MT part of the WTRU is attempting to re-establish the PDU session.

The WTRU may send a notification to the PINE about the state of the IP connection, and/or the reason for change. The PINE may take appropriate action in response to the notification about the state of the IP connection, such as buffer, pause, and/or delay sending data associated with the session.

When the PDU session returns to normal operation, the WTRU may become aware of a change in connection state, e.g. to normal and/or improved. The PEMC client may become aware when the PEMC client receives notification from a PIN server, an AF, and/or a PEGC client. The PIN server may become aware of the state change based on a notification from 5GC. The AF may become aware of the state change based on a notification from 5GC through NEF. The PEGC client may become aware of the state change based on a notification from the MT part of the WTRU.

The WTRU may notify the PINE about the change with status and any event such as change in IP address, etc. The PINE may then take appropriate action and/or resume operation.

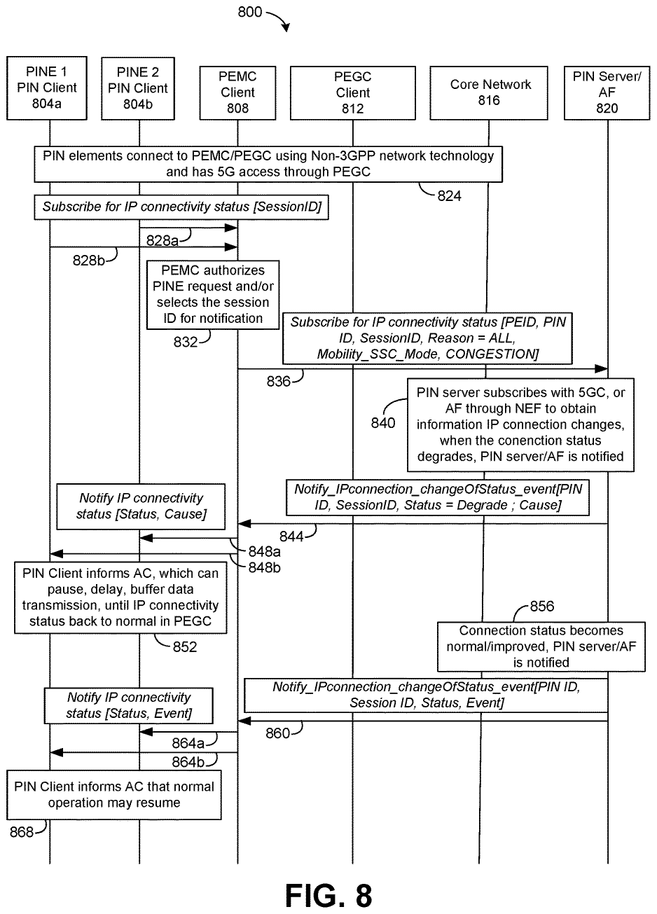

A PEMC client (e.g., a PEMC client in a WTRU) may notify a PINE about IP connection status by obtaining information from 5GC (e.g., such as a PIN server and/or an AF). FIG. 8 depicts an example procedure 800 for a PEMC client 808 to use to notify a PINE about IP connection status. At 824, PINE 1 and/or PINE 2 may be part of the PIN 804a, 804b and may be allowed to connect to the network 816 (e.g., 5GC) through the PEGC client 812. An AC in the PINE may setup an IP session with the network 816 (e.g., 5GC) through the PEGC client 812.

An AC in the PINE may trigger the PIN client 804a, 804b to subscribe for IP connection status related notifications. The PIN client 804a, 804b may subscribe to the PEMC client 808 to get notified about IP connection changes for various reasons like mobility, change in IP address, congestion in DNN, and/or release and re-establish etc. At 828a, 828b, the subscription request may include the session ID that the PINE client may request notification about. The PIN client 804a, 804b may subscribe to be notified for a specific reason and/or all reasons.

At 832, the PEMC client 808 may authorize the PIN client 804a, 804b and/or select the session ID to be monitored.

At 836, the PEMC client 808 may subscribe to the PIN server and/or AF 820 for PIN, to be notified about status changes for the selected session ID. The PEMC client 808 may subscribe to get notified about IP connection events for various reasons like mobility, change in IP address, congestion in DNN, release and/or re-establish of PDU session, etc. The PEMC client 808 may subscribe to be notified for a specific reason and/or for any reason.

At 840, the PIN server and/or the AF 820 for the PIN may select the PDU session, which the PEMC client wants to be notified about, for example, based on PINE ID, PIN ID, and/or session ID. The PIN server and/or AF 820 for PIN may start monitoring the PDU session for change in connectivity status due to mobility, SSC mode, congestion, release and re-establish and/or other reasons by subscribing to events related to the PDU session, using 5GC API and/or via NEF. The network 816 (e.g., 5GC) may provide a cause value for the PDU session modification and update. The PEMC client 808 may be notified about the cause through 5GC APIs and/or via NEF.

The PIN server and/or AF 820 for PIN may be notified, when the session identified by the session ID, experiences IP level connectivity status changes. The PIN server and/or AF 820 for PIN may be informed about the connectivity status along with the cause code such as mobility and/or SSC mode, congestion control from 5GC using published APIs, via NEF, etc.

At 844, the PIN server and/or AF 820 for PIN may notify the PEMC client 808 about the change related to IP connection identified by session ID. The notification may include cause for such changes. The notification may indicate change in IP address and/or assignment of two IP addresses for the PDU session. The notification may indicate that IP connection is disabled for certain period of time along with a timer value.

At 848a, 848b, the PEMC client 808 may forward the notification to the PIN clients 804a, 804b in PINE which has subscribed to be notified. The notification may inform the PIN client 804a, 804b about IP connection disruption with possible cause such as “change in IP address, SSC Mode2,” “connection migration, SSC mode 3,” “congestion with a timer, SM,” and/or “release and re-establish,” etc. The notification may send notification message to those PINEs, which subscribed to get notified. The notification may indicate that the IP connection is temporarily disabled. The notification may indicate that the IP connection is intact, but the IP address has changed. The notification may indicate the new IP address. The notification may indicate that the IP connection is intact, but that the connection is now associated with two IP addresses. The notification may indicate the IP address(es) associated with the connection. The notification may indicate that an IP address may no longer be associated with the connection. The notification may include a time value that indicates how long the IP connection may be disabled. The time value may be based on a back-off timer received from the network. The notification may indicate that the IP connection may no longer be disabled (e.g., enabled).

At 852, the PIN client 804a, 804b may select the AC based on PIN ID and/or session ID. The PIN client 804a, 804b may inform the AC about the “IP connection status change” notification. The AC may take actions based on the IP connection status change, e.g., to continue the session and not reset and/or re-establish connection.

If the IP connection is temporarily disabled and a new IP address is going to be assigned, the AC may start buffering IP packets and/or pause the application temporarily so that new IP packets are not generated.

If the IP connection is temporarily impacted because the PDU session has been assigned two IP addresses and one IP address will no longer be associated, the AC may buffer IP packets. Buffering IP packets may allow the application to retransmit if any packets may be lost during transition. The AC may generate application packets at a slower rate.

If the IP connection is temporarily unavailable indicated by a time value, the AC may pause the application from generating IP packets for the same amount of time.

At 856, when the IP connection issue for the specific session ID and/or PIN ID resolves, the network 816 (e.g., 5GC) may notify the PIN server and/or the AF 820 for PIN about the changed connection status.

At 860, the PIN server and/or AF 820 for PIN may inform the PEMC 808 client about the change in connection status, such as, e.g., current state of the connection and/or any event that happened (e.g., changed IP address of the PEGC 812). The notification may indicate that the issues with the PDU session associated with the IP connection may have resolved. The notification may indicate that the IP connection is in normal situation and the IP connection is intact. The notification may indicate if the IP address and/or port number have changed in the PEGC. The notification may indicate that the IP connection is no longer disabled (e.g. enabled).

At 864a, 864b, based on the notification received by PEMC client 808, the PEMC client 808 may become aware of the condition that the IP connection issue for the specific session ID and/or PIN ID is resolved at the PEGC. The PEMC client 808 may send another notification to the PIN client 804a, 804b, with information such as, e.g., state of the connection and/or optionally any event that happened such as, a changed IP address (e.g., IPv6 prefix) of PEGC, and/or a new port number.

The notification may indicate that the issues with the PDU session associated with the IP connection may have resolved. The notification may indicate that the IP connection is in a normal situation and/or the IP connection is intact. The notification may also include an indication about new IP address assigned to PEGC. The notification may indicate that the IP connection is no longer disabled (e.g., enabled).

At 868, the PIN client may inform the AC about the IP connection status change notification received. The AC, after receiving the notification, may abort any action(s) initiated to continue the session.

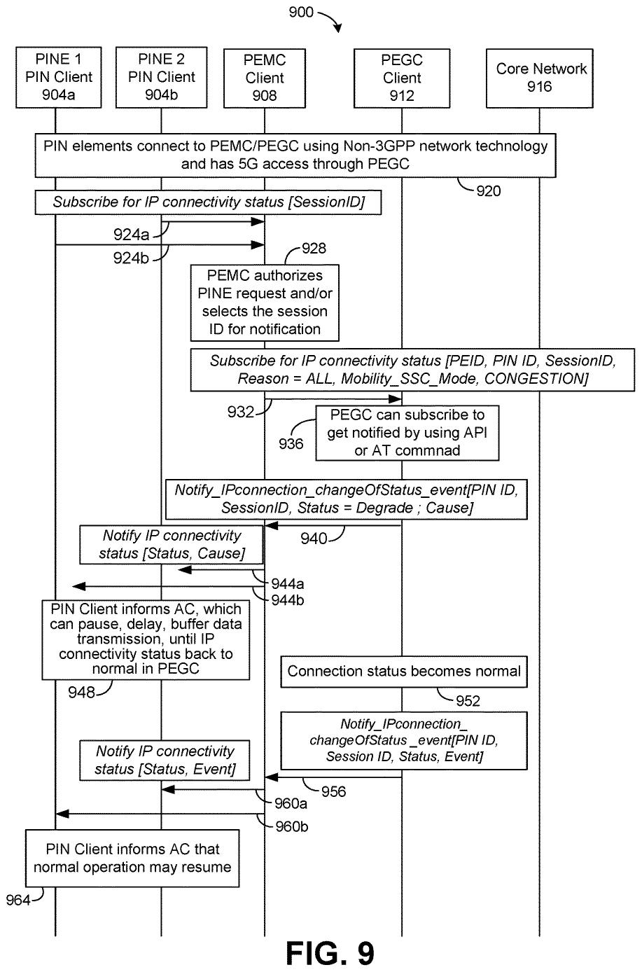

Alternatively, the PEMC client may notify a PINE about IP connectivity status by obtaining information from a PEGC client. FIG. 9 depicts an example procedure 900 for a PEMC client 908 to notify a PINE by obtaining information from a PEGC client 912. PINE 1 and/or PINE 2 may be part of the PIN 904a, 904b and may be allowed to connect to the network 916 (e.g., 5GC) through the PEGC 912. AC in PINE may setup an IP session with the network 916 (e.g., 5GC) through the PEGC 912.

At 924a, 924b, the AC in the PINE may trigger the PIN client 904a, 904b to subscribe for IP connection status related notifications. The PIN client 904a, 904b may subscribe to the PEMC client 908 to get notified about IP connection changes for various reasons like mobility, change in IP address, congestion in DNN, and/or release and re-establish, etc. At 924a, 924b, the subscription request may include the session ID that the PINE client may request to be notified about. The PIN client 904a, 904b may subscribe to be notified for a specific reason and/or all reasons.

At 928, the PEMC client 908 may authorize the PIN client 904a, 904b. The PEMC client 908 may select the session ID to be monitored.

At 932, the PEMC client 908 may subscribe to the PEGC client 912. The PEMC client 908 may subscribe to be notified about any status changes for the selected session ID, IP connection events for various reasons like mobility, change in IP address, congestion in DNN, and/or release and re-establish of PDU session etc. The PEMC client 908 may subscribe to be notified for a specific reason and/or for any reason. The subscription request may include the session ID that the PEMC client 908 may request notification about.

At 936, the PEGC client 912 may select the PDU session, which the PEMC client 908 wants to be notified about, based on PINE ID, PIN ID, and/or session ID. The PEGC client 912 may start monitoring the PDU session for change in connectivity status due to mobility, SSC mode, congestion, release and/or re-establish or other reasons by subscribing to events related to the PDU session, using API and/or AT commands. The network 916 (e.g., 5GC) may provide a cause value in the PEGC client 912 for PDU session modification and/or update. The PEGC client 912 may be notified about the cause through APIs and/or AT commands, etc.

At 940, the PEGC client 912 may experience IP level connectivity status change for the PDU session selected. For example, the PEGC client 912 may identify, at 940, a change to the IP connection (e.g., that is identified by the session ID). The PEGC client 912 may be informed about the connectivity status and/or the cause such as mobility and/or SSC mode, congestion control, and/or release and re-establish from the network 916 (e.g., 5GC).

The PEGC client 912 may inform the PEMC client 908 about IP connection disruption with possible cause such as “change in IP address, SSC Mode2,” “connection migration, SSC mode 3,” “congestion with a timer, SM,” and/or “release and re-establish,” etc. For example, the PEGC client 912 may send at 940 a notification that indicates the change to the IP connection and the cause of the change to the IP connection. The PEGC client 912 may send a notification message to PEMC client 908, which subscribed to get notified. The notification may indicate that the IP connection may be temporarily disabled. The notification may indicate that the IP connection may be intact, but the IP address had changed. The notification may indicate the new IP address. The notification may indicate that the IP connection may be intact, but that the connection may now be associated with two IP addresses. The notification may indicate that the IP address(es) may be associated with the connection. The notification may indicate that an IP address may no longer be associated with the connection. The notification may include a time value that indications how long the IP connection may be disabled. The time value may be based on a back-off timer that was received from the network. The notification may indicate that the IP connection is no longer disabled (e.g., enabled).

At 944a, 944b, the PEMC client 908 may forward the notification, received from the PEGC client 912, to the PIN clients 904a, 904b in PINE which may have subscribed to be notified. The notification may inform PIN client 904a, 904b about IP connection disruption with possible cause such as “change in IP address, SSC Mode2,” “connection migration, SSC mode 3,” “congestion with a timer, SM,” and/or “release and re-establish,” etc. The PEGC client 912 may send a notification message to those PINEs, which subscribed to get notified. The notification may indicate that the IP connection may be temporarily disabled. The notification may indicate that the IP connection is intact. The notification may indicate the IP address has changed and/or the notification may indicate the new IP address. The notification may indicate that the IP connection may be intact, but that the connection may now be associated with two IP addresses. The notification may indicate the IP address(es) associated with the connection. The notification may indicate that an IP address may no longer be associated with the connection. The notification may include a time value that indications how long the IP connection may be disabled. The time value may be based on a back-off timer received from the network. The notification may indicate that the IP connection may no longer be disabled (e.g. enabled).

At 948, the PIN client 904a, 904b may select the AC based on PIN ID and/or session ID. The PIN client 904a, 904b informs AC about the “IP Connection status change” notification. The AC may take actions e.g., to continue the session and/or not reset and/or re-establish connection.

If the IP connection is temporarily disabled and a new IP address is going to be assigned, the AC may start buffering IP packets and/or pause the application temporarily so that new IP packets are not generated.

If the IP connection is temporarily impacted because the PDU session has been assigned two IP addresses and one IP address will no longer be associated, the AC may buffer IP packets. Buffering IP packets may allow the application to retransmit if any packets are lost during transition. The AC may also generate application packets at a slower rate.

If the IP connection is temporarily unavailable indicated by a time value, the AC may also pause the application from generating IP packets for the same amount of time.

At 952, when the IP connection issue for the specific session ID and PIN ID is resolved, the PEGC client 912 may be notified about the changed connection status. For example, the PEGC client 912 may determine that the IP connection has returned to normal operation, for example, based on receipt of a notification from a PIN server, an application function, or the PEMC client 908.

At 956, the PEGC client 912 may send another notification to PEMC client 908, to indicate that the IP connection issues may have resolved at PEGC, with information such as state of the connection and/or optionally any event that happened such as, changed IP address (e.g., IPv6 prefix) of PEGC, and/or new port number.

The notification sent at 956 may indicate that the issues with the PDU session associated with the IP connection may have resolved. The notification may indicate that the IP connection is in a normal situation and the IP connection may be intact. The notification may include the IP address, if the IP address changed. The notification may also include a new IP address assigned to PINE, when there may be no NAT. The notification may include a port number if the port number changed. The notification may indicate that the IP connection may no longer be disabled (e.g., enabled).

At 960a, 960b, based on the notification received by the PEMC client 912, the PEMC client 912 may become aware of the condition that the IP connection issue for the specific session ID and/or PIN ID may resolve at the PEGC. The PEMC client 912 may send another notification to PIN client 904a, 904b, with information such as state of the connection and/or optionally any event that happened such as, changed IP address (e.g., IPv6 prefix) of PEGC, and/or a new port number.

The notification may indicate that the issues with the PDU session associated with the IP connection may have resolved. The notification may indicate that the IP connection may be in normal situation and the IP connection is intact. The notification may also include indications about new IP address assigned to PEGC. The notification may indicate that the IP connection is no longer disabled (e.g., enabled).

At 964, the PIN client 904a, 904b may inform the AC about the IP connection status change notification received. The AC, after getting the notification, may abort any action initiated to continue the session.

What is claimed is:

1-20. (canceled)

21. A first wireless transmit/receive unit (WTRU) connected to a network via a first connection comprising:
a processor, the processor configured to:
connect to a second WTRU via a second connection;
receive, from the second WTRU, one or more subscription requests, wherein each subscription request of the one or more subscription requests comprises a session identifier (ID), wherein the session ID comprises information associated with the first connection, and the subscription request further comprises a request to notify the second WTRU of an event associated with the first connection;
select the first connection based on the session ID; and
send, to the second WTRU via the second connection, a first notification message indicating the event associated with the first connection.

22. The first WTRU of claim 21, wherein the first connection is an internet protocol (IP) connection.

23. The first WTRU of claim 21, wherein each subscription request of the one or more subscription requests further indicates one or more events that change the connection and trigger the first WTRU to send the first notification message.

24. The first WTRU of claim 23, wherein the one or more events is one or more of a detection of non-access stratum (NAS), mobility management (MM) congestion control, detection of NAS session management (SM) congestion control, an indication of the mobility of the first WTRU, a change in internet protocol (IP) address of the first WTRU, congestion associated with a data network name (DNN), release of a packet data unit (PDU) session, or re-establishment of the PDU session.

25. The first WTRU of claim 21, wherein when the connection stops when the second WTRU buffers, pauses, or delays sending data associated with the connection.

26. The first WTRU of claim 21, wherein the first notification message indicates one or more of an internet protocol (IP) connection associated with the first connection is temporarily disabled, an IP address associated with the IP connection has changed or is disabled, or indicating a duration of the event.

27. The first WTRU of claim 21, wherein the first notification message comprises personal internet of things (PIN) connectivity information, wherein PIN connectivity information indicates one or more of a PIN ID, a PIN client ID, a PIN gateway client (PEGC) ID, or an indication of a type of event that established a connection.

28. The first WTRU of claim 21, the processor configured to:
send, to the second WTRU via a second notification message, an internet protocol (IP) address associated with the first connection, wherein the IP address associated with the first connection is sent based on resolution of an issue with the first connection.

29. The first WTRU of claim 28, the processor configured to:
send, to the second WTRU via a second notification message, an indication that the first connection is no longer associated with the IP address, wherein the indication that the first connection is no longer associated with the IP address is sent based on the event associated with the first connection.

30. The first WTRU of claim 21, the processor configured to:
send, to the second WTRU via a second notification message, an internet protocol (IP) address assigned to the second WTRU, wherein the IP address assigned to the second WTRU is sent based on resolution of an issue with the first connection.

31. A method implemented by a first wireless transmit/receive unit (WTRU), the method comprising:
connecting to a second WTRU via a second connection;
receiving, from the second WTRU, one or more subscription requests, wherein each subscription request of the one or more subscription requests comprises a session identifier (ID), wherein the session ID comprises information associated with the first connection, and the subscription request further comprises a request to notify the second WTRU of an event associated with the first connection;
selecting the first connection based on the session ID; and
sending, to the second WTRU via the second connection, a first notification message indicating the event associated with the first connection.

32. The method of claim 31, wherein the first connection is an internet protocol (IP) connection.

33. The method of claim 11, wherein each subscription request of the one or more subscription requests further indicates one or more events that change the connection and trigger the first WTRU to send the first notification message.

34. The method of claim 33, wherein the one or more events is one or more of a detection of non-access stratum (NAS), mobility management (MM) congestion control, detection of NAS session management (SM) congestion control, an indication of the mobility of the first WTRU, a change in internet protocol (IP) address of the first WTRU, congestion associated with a data network name (DNN), release of a packet data unit (PDU) session, or re-establishment of the PDU session.

35. The method of claim 31, wherein when the connection stops when the second WTRU buffers, pauses, or delays sending data associated with the connection.

36. The method of claim 31, wherein the first notification message indicates one or more of an internet protocol (IP) connection associated with the first connection is temporarily disabled, an IP address associated with the IP connection has changed or is disabled, or indicating a duration of the event.

37. The method of claim 31, wherein the first notification message comprises personal internet of things (PIN) connectivity information, wherein PIN connectivity information indicates one or more of a PIN ID, a PIN client ID, a PIN gateway client (PEGC) ID, or an indication of a type of event that established a connection.

38. The method of claim 31, further comprising:
sending, to the second WTRU via a second notification message, an internet protocol (IP) address associated with the first connection, wherein the IP address associated with the first connection is sent based on resolution of an issue with the first connection.

39. The method of claim 38, further comprising:
sending, to the second WTRU via a second notification message, an indication that the first connection is no longer associated with the IP address, wherein the indication that the first connection is no longer associated with the IP address is sent based on the event associated with the first connection.

40. The method of claim 31, further comprising:
sending, to the second WTRU via a second notification message, an internet protocol (IP) address assigned to the second WTRU, wherein the IP address assigned to the second WTRU is sent based on resolution of an issue with the first connection.
